(19) United States
(12) Patent Application Publication
(10) Pub. No.: US 2001/0027407 A1
(43) Pub. Date: Oct. 4, 2001

(54) Control and inquiry system for construction work

(76) Inventor: Kazuhiko Mori, Tokyo (JP)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/765,221

(22) Filed: Jan. 18, 2001

(30) Foreign Application Priority Data
Apr. 4, 2000 (JP) 2000-103788

(51) Int. Cl. G06F 17/60

(52) U.S. Cl. 705/9; 705/1

(57) ABSTRACT

A control and inquiry system handles construction project information that is related to the construction of a building. The construction project information includes content information, work schedule information, work progress information and change order information and is maintained on a control and inquiry computer system that is coupled to a computer network. Construction project information may be accessed by a home builder computer system and a client computer system that are also coupled to the computer network.

### FIELD OF THE INVENTION

The present invention relates to a control and inquiry system, and more specifically to a control and inquiry system for handling construction project information on dwelling houses and other types of buildings.

### BACKGROUND OF THE INVENTION

The manner in which a building is constructed is somewhat unique, irrespective of whether the building is newly constructed, added to or remodeled. Consequently, when the construction work has been completed, it is often difficult to determine whether the respective work stages were completed properly. While the control of such construction work has sometimes been carried out partially using a computer, such control has been carried out only for the benefit of the constructor, for example, the home builder (e.g., a general contractor) and the information has rarely been offered to a client (e.g., a homebuyer). Even when offered to the client, such information has often been incomplete and has contained many technical terms often too difficult to be understood by the client.

Additionally, unlike the site superintendent, it is practically impossible for the client to observe the entire construction process. While it has been possible for the client to attend one or more important work stages, it has usually been difficult for the client to attend each individual work stage. This is, at least in part, because the construction process rarely follows an initial work schedule. Accordingly, even if the client prearranges a date of attendance at the construction site, on the basis of the initial schedule, the schedule is often changed before the date of attendance. Furthermore, the general contractor often fails to inform the client of schedule changes.

In view of the present situation, the client is typically left with entrusting the constructor with the work and even if the client discovers a defect, various barriers, including communication barriers, prevent the client from resolving the problem. Further, controlling the work progress has conventionally also been difficult for the constructor (e.g., the general contractor) since the actual work progress has typically been left to visual inspection and judgment by a site superintendent.

Upon completion, many of the essential parts constituting a building, such as a dwelling house, cannot be checked or inspected unless the building is partially destroyed. It is also difficult for the constructor to record the inspection results, together with the relevant image data or the like, and to store them in a computer so that such information may be readable in a random access fashion.

### SUMMARY OF THE INVENTION

The present invention is directed to a control and inquiry system for handling construction project information that is related to the construction of a building. The construction project information includes content information, work schedule information, work progress information and change order information. The system includes a control and inquiry computer system, a home builder computer system and a client computer system that are each coupled to a computer network. The control and inquiry computer system stores construction project information and executes control and inquiry code causing the control and inquiry computer system to perform a number of steps. Initially, the control and inquiry computer system receives content information that is related to the design of the building from the home builder computer system. Next, the control and inquiry computer system receives work schedule information that indicates a projected schedule as to when various construction stages of the building are to be completed from the home builder computer system. Then, work progress information that indicates the actual progress of the building is received. Next, change order information, which is directed to changes in the design of the building, are received. Finally, the construction project information is provided to an authorized party when requested.

These and other features, advantages and objects of the present invention will be further understood and appreciated by those skilled in the art by reference to the following specification, claims, and appended drawings.

### BRIEF DESCRIPTION OF THE DRAWINGS

In the drawings:

FIG. 1A is a block diagram of an exemplary computer network; and

FIGS. 1B-7 are diagrams illustrating information flow from/to an exemplary control and inquiry system.

### DETAILED DESCRIPTION OF THE PREFERRED EMBODIMENT(S)

The present invention is directed to a control and inquiry system S for monitoring the progress of construction work. The system S stores various kinds of construction project information and is adapted to be used in a computer environment supported by a network, such as the Internet. The construction project information typically includes content, work schedule, work progress and change information and may include liaison information relating to communication with a client. The system S maintains the information, under a time control, and is available to the home builder (e.g., the general contractor) and the client (e.g., the homebuyer), when desired. Further, the system S can store occasional information including wishes, claims, agreements and communications from the client, under a time control, and make such information available to the home builder and the client, as desired.

The system S, according to the invention, prompts the home builder to input thereto and to store therein the fundamental information relating to content and work stages. Then, the system S prompts the home builder to input day-by day and hour-by-hour work progress. As occasion demands, the system S prompts the home builder to input information relating to a change in the work program, the work content or the like, as well as the liaison information for communication with the client. This information is stored in the system S, under a time control, so as to be available to the constructor, as well as to the client, in random access fashion. In this way, the system S relieves the home builder from the task of accumulating the work schedule, the work progress information, the claims from the client or the like in his/her own computer. More specifically, the home builder can read and store the respective kinds of information merely by accessing the system S, according to the invention, while the client can confirm desired information, such as the work schedule and the work progress input by the home builder, via the network, instead of directly attending the work-site. When any question arises or any defect is discovered, the client can notify the home builder to, for example, make a desired repair.

The stored information may include fundamental information, work progress information, change information, liaison information and the like, which are offered so as to be available to a third person when the work is open to the general public (e.g., construction of tract houses). However, once the negotiation of a sales contract has begun, the information is preferably, only available to an authorized person specified by ID number, password, voiceprint, cryptograph software or the like. In this way, the home builder can provide information on available dwelling houses to the general public to improve sales. Further, a client can be informed of the work contents, as has conventionally been impossible, and thereby enter the sales contract with less anxiety. Once negotiation of the sales contract has been entered, the availability of the information offered can be limited, when desired, by ID information. Thus, privacy as well as security of the client can be maintained.

A standard schedule forms the basis for the fundamental information that is offered to the home builder. The fundamental information may also include the change information relating to a change made by the home builder in the standard schedule, reason for such change and a comparison between the initial standard schedule and the changed schedule. In this way, characteristics (e.g., quality) of a particular building can be documented and made available to the home builder and the client for future use.

The fundamental information may include profiles of the home builder, a site superintendent, subcontractors and collaborating companies for each work stage, including their images. In this way, the relationship between a home builder and client may be enhanced and misunderstandings reduced.

The operation of inputting the work progress information into the system S in accordance with the work schedule is, preferably, fulfilled merely by checking work items on the entire work schedule to be carried out on a given day, providing the work progresses in accordance with the work program. In this manner, the operation of inputting the work progress by the site superintendent or the like can be sped up and simplified.

Preferably, the site superintendent transmits the actual work progress each day, via his/her own personal computer or the like. If the site superintendent fails to update the work schedule, on a scheduled workday, the system S preferably sends out a warning to a portable telephone or the like of the site superintendent and/or to the home builder advising of the oversight.

According to the invention, the site superintendent also receives the work program for each day via his or her own personal computer or the like so that the site superintendent can confirm the schedule every morning. Additionally, both the home builder and the client can confirm the actual work progress and the work schedule on that day on the basis of the work progress having been confirmed on the previous day. The work progress information may include inspection results inclusive of photo, dynamic image or the like obtained from checking each item for each stage and each content.

According to the invention, completion of each work stage can be reliably confirmed from the inspection results which can include still images, dynamic images or the like obtained from checking each item at each stage and each work content contained in the work progress information. Data contained in the inspection results for each item for each stage allow the home builder or the site superintendent to evaluate the work. For current or future defects, such data is useful to analyze components, which are difficult to inspect after work completion (e.g., components concealed within walls).

The work progress information reporting completion of each work stage preferably includes a plurality of separate stage completion information including image data supporting an identity of the information contents reported by at least two of the site superintendent, the subcontractors and the like, which increases the reliability of the completion information on each work stage.

Preferably, the system S instructs payment to a subcontractor after confirming that a work stage for which the subcontractor was responsible has been completed. According to the invention, confirmation that each work stage contained in the work progress information has been completed may be related to instruction of payment to the relevant subcontractor to promote completion of the work stage and thereby to assure such payment upon work stage completion. Preferably, the system S is unable to instruct commencement of a future work stage, when a previous essential work stage is not complete.

The information transmitted to the personal computer or the like or the portable telephone of the home builder or the client is, preferably, readable in the form of image data comprising photo, dynamic image, sound or the like. In a preferred embodiment, the respective kinds of information are accompanied with readout confirming means by which the home builder or the client may confirm that the respective kinds of information were readout, which allows effective use of the system S and thereby promotes smooth work progress.

Preferably, the system S gives a warning in the form of sounds, oscillation and/or light emission to the personal computer or the portable telephone of the home builder, the site superintendent, the subcontractor or the client and thereby prompts them to input the work progress information, the liaison information or the occasional information if input of any one of these kinds of information is delayed.

The system S is adapted to communicate with the networked personal computer or the portable telephone designated by the client, if the client has previously notified the system S of his or her absence. According to the invention, when absent from home, the client can receive the work progress at any place. When the work progress information indicates a delay with respect to the work schedule, the system S is adapted to give the home builder a warning and thereby prompt the home builder to input a counter-measure to overcome the delay.

When the work progress information indicates a change with respect to the work schedule, the system S is adapted to prompt the home builder to input change information; including a changed work schedule, a reason for the change and a comparison between the initial work schedule and the changed work schedule. According to the invention, the client is reliably supplied with the change information including the changed work schedule, the reason for the change and a comparison between the initial work schedule and the changed work schedule.

When a client desires to attend the work-site, the client may designate the relevant work stage in the work schedule table and input a desired date of attendance to inform the home builder, the site superintendent or the like of the desired date and finally determine the actual date of attendance by making arrangements as to the date of attendance.

The work progress information may include image data comprising still images or dynamic images showing real-time progress on the work-site. According to the invention, the work progress can be real-time monitored by means of the image data such as still image or dynamic image transmitted from the work-site even when it is impossible for the client, the home builder or the superintendent to be present at the work-site.

Preferably, a warning is provided to the personal computer or the portable telephone of the home builder or the site superintendent when a defect or a problem is discovered by the client or the system S. The system S is adapted to schedule/control a program of repair based on a claim from the client or the system S.

The liaison information may include supplementary information relating to whereabouts of the site superintendent or the subcontractor. According to the invention, the liaison information transmitted from the site superintendent or the subcontractor contains supplementary information relating to the whereabouts of the site superintendent or the subcontractor so that the client or the system S may confirm whether the information has been transmitted from the work-site. The supplementary information relating to the whereabouts of the site superintendent or the subcontractor is typically based on the whereabouts of the portable telephone or the like carried by the site superintendent or subcontractor.

Preferably, the system S periodically informs the home builder or the client of conformity or non-conformity between the site where the site superintendent or the subcontractor is scheduled to be present and the actual whereabouts of the site superintendent or subcontractor, indicated by the supplementary information via a portable telephone or the like.

The fundamental information relating to content as well as work stage, the work progress information relating to the actual work progress, the change information relating to change in the content and stage and the like and the liaison information, each offered from the home builder to the client are, preferably, accompanied with a brief explanation. According to the invention, when the client cannot understand names of respective work stages, technical terms and special terms commonly used by those skilled in the art, these may be designated or retrieved by clicking to read a detailed explanation for the term. The respective kinds of information relating to the site superintendent, the delayed work stage, the relevant building, the client, the work stages and a claim from the client are preferably added for later retrieval.

According to the invention, the respective kinds of information stored in the system S for the respective work stages and the respective principal members may be retrieved later so that how to handle these members, possible occurring trouble, a term of guarantee, a window for after-service and the like may be understood on the basis of particular members, as well as particular subcontractors responsible for the respective work stages and the manufacturers of the respective members.

The respective kinds of information relating to the work progress, delayed work stage, changed work stage, cause of the delay, reason for the change, the site superintendent responsible for the delay and the subcontractor responsible for the delay and the like are added with an analyzing feature. According to the invention, the work progress can be characterized with the analyzing feature.

The system S stores all kinds of information in the place of the home builder, the client and the like so that the home builder, the client and the like may inquire of the system S about contents of the respective kinds of information. According to the invention, both the home builder and the client are relieved from troublesome operation of accumulating the information relating to the work and can access the system S, according to the invention, to obtain desired information, as needed.

Preferably, the system S can be accessed, as occasion demands, for a given period after work completion. According to the invention, even after the work has been completed, the present state of the work can be inspected by accessing the system S, unless the term of guarantee or the term of information offering contract expires.

Preferably, the system S provides a warning to the personal computer or the portable telephone of the client, the home builder, the site superintendent or the subcontractor, in the form of letters, sound, oscillation, light emission or the like when the liaison information or the occasional information is an emergency. According to the invention, a warning is given to the personal computer or the portable telephone or the like of the client, the home builder, the site superintendent or the subcontractor in the case of emergency to prompt them to read the information as soon as possible.

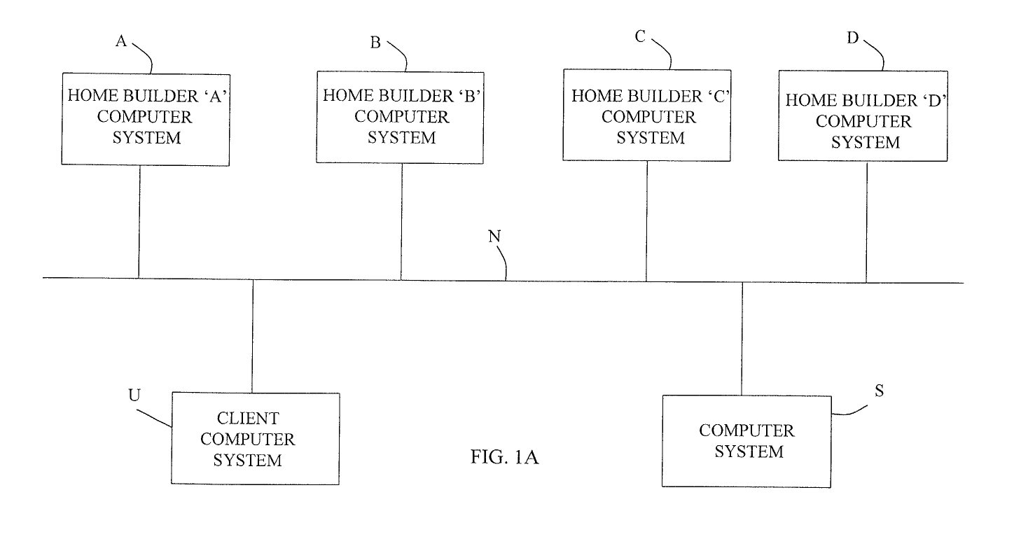

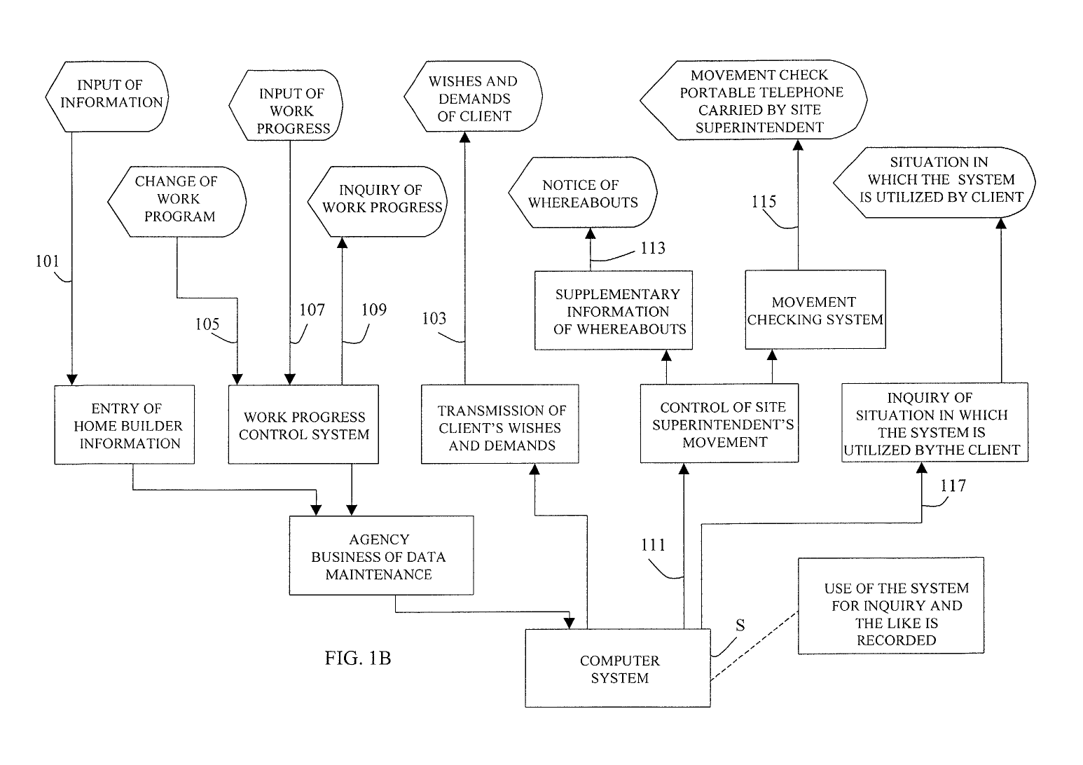

FIG. 1A is a block diagram of an exemplary computer network that allows a plurality of home builder computer systems A, B, C and D and a client computer system U to communicate with a work progress control and inquiry computer system S, via a network N, such as the Internet. While only one system S is shown, it is envisioned that the system S may include multiple networked computer systems.

As a general rule, access to the system S is limited to the home builders and the clients specified by ID information, such as ID numbers, passwords, voiceprints and cryptograph software, in order to provide information security. However, in the case of tract house construction, which is usually open to the public; primary information, work progress information, change information, communication or the like can be made available to third parties. Preferably, when sales contract negotiations begin, more detailed information is offered only to a relevant person that has specified ID information. In this manner, reliable information on the dwelling houses can be provided to the public to enhance sales. Furthermore, the details of the construction work, which have usually been unavailable to third persons, can be made available and the sales contract can be entered into with less anxiety. In addition, once the sales contract negotiation has been entered, further detailed information can be limited to individuals specified by ID information so that personal privacy can be maintained.

A prospective purchaser can confirm the progress of the construction work if the system S is linked to a home page of a house selling company (e.g., a realtor) in which the dwelling houses are listed. Making relevant images available to prospective purchasers increases the reliability of the construction work. When a contract is entered, the system S can automatically unlink from the home page and thereafter provide access to information only to the client and the home builders.

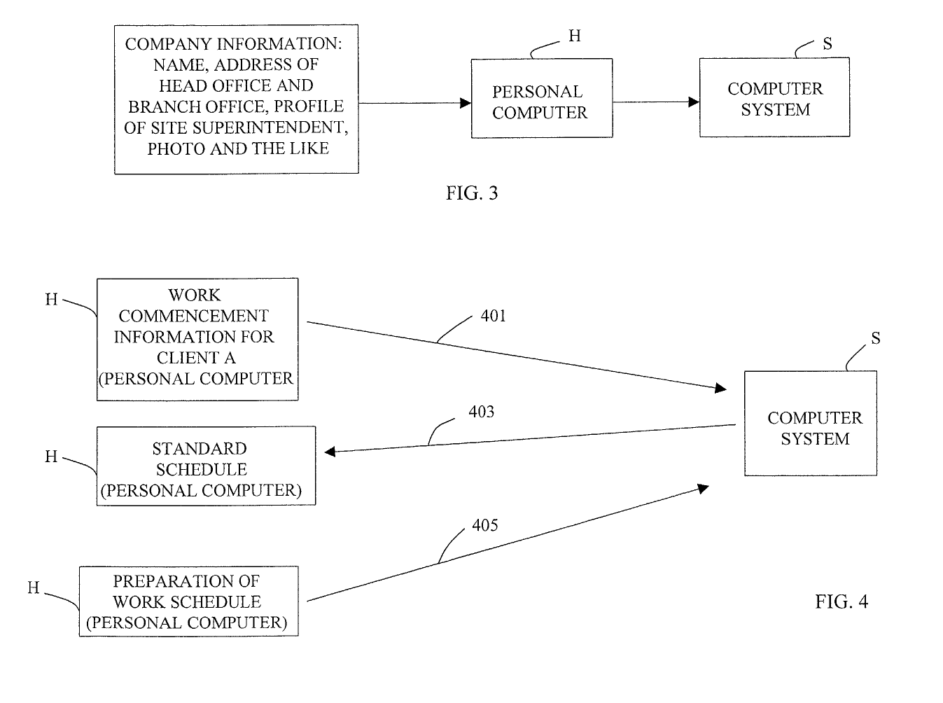

As shown in FIG. 1B, the home builder inputs 101 primary information into a personal computer (e.g., computer system A of FIG. 1A), which is then transferred to the system S via, for example, the Internet (see FIG. 3). The primary information may include a company name, addresses of the head office, branch offices and liaison offices, a responsible liaison, a site superintendent, subcontractors and collaborating companies. The primary information may further include an outline of the company, actual situation of management, record of orders received, a photo of a company head and branch offices, photo, experience, qualification, self-introduction and the like of a site superintendent together with a dynamic image. The primary information is provided to the system S in the order of priority, according to the model case prepared for the system S, so that the clients may read the information and entrust the home builder with the construction work with less anxiety.

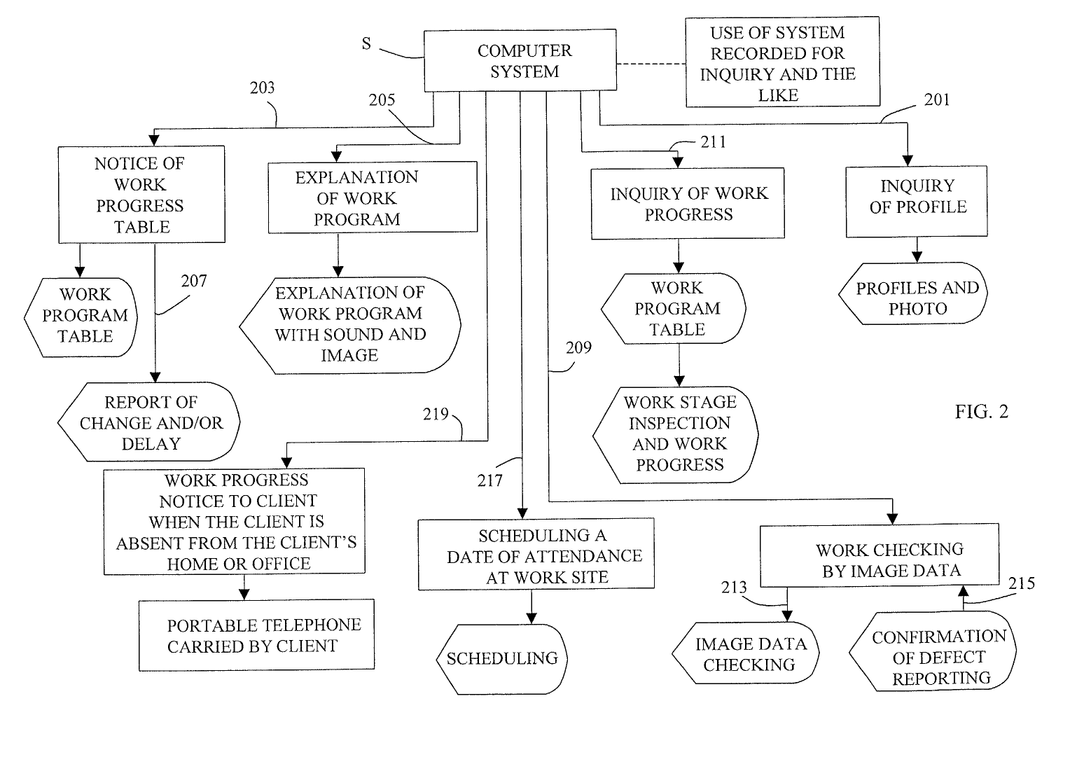

While the content of such information should be made, as a rule, for every client and every project, all the items except the items depending on the particular client and project, i.e., all the items common to all clients and projects are permanently stored in the system S and offered to the home builder. Accordingly, after the fundamental information has been input to the system S, it is only necessary for the home builder to input the client and work-site dependent items to the system S for each client and work-site. As shown in FIG. 2, the fundamental information (i.e., profiles and photos) is provided 201 by the system S to the personal computer U of the client (see FIG. 1A), via the Internet, so that the client can read the information whenever the client desires.

As shown in FIG. 4, the home builder inputs a work schedule into the computer system H. The system H then transfers 401 the work schedule to the system S as additional fundamental information. In response to work commencement information including, for example, a design drawing and a work commencement date input by the home builder to the system S, via the Internet, the system S delivers 403 a standard model schedule together with explanation on a model case of the work program to the home builder who then corrects the initial input by the home builder work schedule in accordance with the model schedule to make a new work schedule, which is then transferred 405 to the system S. If the new work schedule still has problems, the system S may recommend that the home builder correct and/or supplement the work schedule. When complete, the optimized work schedule is then recorded and stored in the system S.

As shown in FIG. 2, the optimized work schedule is delivered 203 as a notice of work program to the personal computer A or the like or the portable telephone having a similar function to that of the personal computer via, for example, the Internet, in random access fashion. The explanation on the work program already input into the system S, including comparison of the initial program and the optimized program, is also provided 205 to the client (e.g., through the computer system U) in various forms, such as still image, dynamic image, sound or the like.

As shown in FIG. 1B, occasional information, that may include demands, wishes and inquiries is transmitted 103 in random access fashion from the client (i.e., computer system U) to the personal computer A or the like of the home builder, via the system S. While not illustrated, the reply from the home builder is transmitted to the personal computer U or the like of the client via the system S and if the program or the detail of work involves any change, the change information relating to changes in the program or the detail of work will be transmitted 105 to the system S as shown in FIG. 1B. Then, such change information including a detailed explanation of the change is transmitted 203, 205 and 207 to the personal computer U or the like of the client as shown in FIG. 2.

Upon commencement of the work, the work progress is input 107 to the computer system A and transferred to the system S as shown in FIG. 1B and the work progress is, in turn, reported 209 and 211 to the client as shown in FIG. 2. In this manner, not only the home builder but also the site superintendent and various subcontractors can monitor each work stage.

While the work progress information is preferably input to the system S each work day, the input of the work progress information in accordance with the work schedule may be replaced by checking a particular item on the work schedule each day when neither a delay nor a change occurs.

Input of the work progress information by the home builder may be further simplified depending on actual work progress. Specifically, it is unnecessary to input anything unless the work schedule involves a defect or delay. Even when the inspection on respective work stages indicates a defect, obstacle and/or delay, the work progress information to be input to the system S may be limited to the information relating to the work stage involving the defect, obstacle and/or delay.

In a preferred implementation, the site superintendent leaves the office after transmitting the work progress for that day to the system S via his or her personal computer or the like. Further, the site superintendent preferably receives the work schedule for each day from the system S via his or her personal computer or the like. If the site superintendent fails to follow the procedure, the system S periodically warns the site superintendent through his or her portable telephone or the like, urging him or her to input the actual work progress. At any given time, the work progress information generally includes results of inspections conducted during each stage as well as for each kind of work (e.g., plumbing, electrical). The result of the inspection included in the work progress information at any point in time preferably includes image data such as a photo or photos made by a digital or video camera, a still image, a dynamic image or the like.

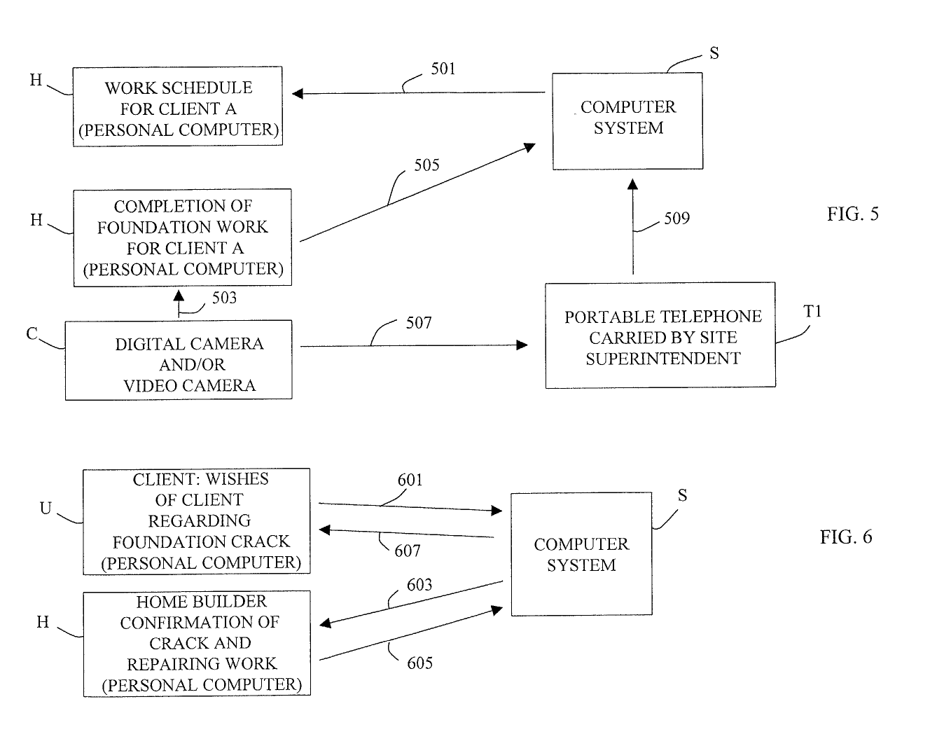

In the case of the embodiment illustrated in FIG. 5, it is assumed that construction work progresses in accordance with the work schedule. The home builder retrieves 501 the work schedule for the client A from the system S and inputs it to his or her own personal computer H or the like and, in addition to this work schedule, inputs 503 a record of important work stages including completion of the foundation work to his or her own personal computer or the like together with still image or dynamic image obtained by using a digital or video camera C and transmits 505 the information to the system S.

The still or dynamic image of the digital or video camera C, respectively, may also be input 507 and real-time transmitted 509 by the site superintendent's portable telephone T1 or the like to the system S via, for example, the Internet. As shown in FIG. 2, the client, in turn, may request the work progress, which is then provided 209 in the form of the still or dynamic image 213 and 215, and, if any defect or the like is found, inform 103 (see FIG. 1A) the site superintendent of the defect, via the system S.

A series of procedures similar to those described above are illustrated in FIG. 6. After reviewing images of the foundation on personal computer U, the client provides 601 notice of a crack in the foundation to the system S. The notice is then transmitted 603 to the personal computer H or the like of the home builder. In response to the notice, the home builder confirms the crack, carries out the repair work and records the repair work in the form of suitable image. The image is then transmitted 605 as the newest work progress information to the system S. The system S then transmits 607 the newest work progress information to the client's personal computer U or the like so that the construction work can be monitored in real-time. Such real-time transmission of the work progress enables image as well as sound of the construction work-site to be offered to the client's personal computer U or the like even if the client cannot attend, for example, the framework raising ceremony.

It is also possible to verify that the image received is that of the correct construction site for each client on the basis of the whereabouts of the site superintendent's portable telephone or the like.

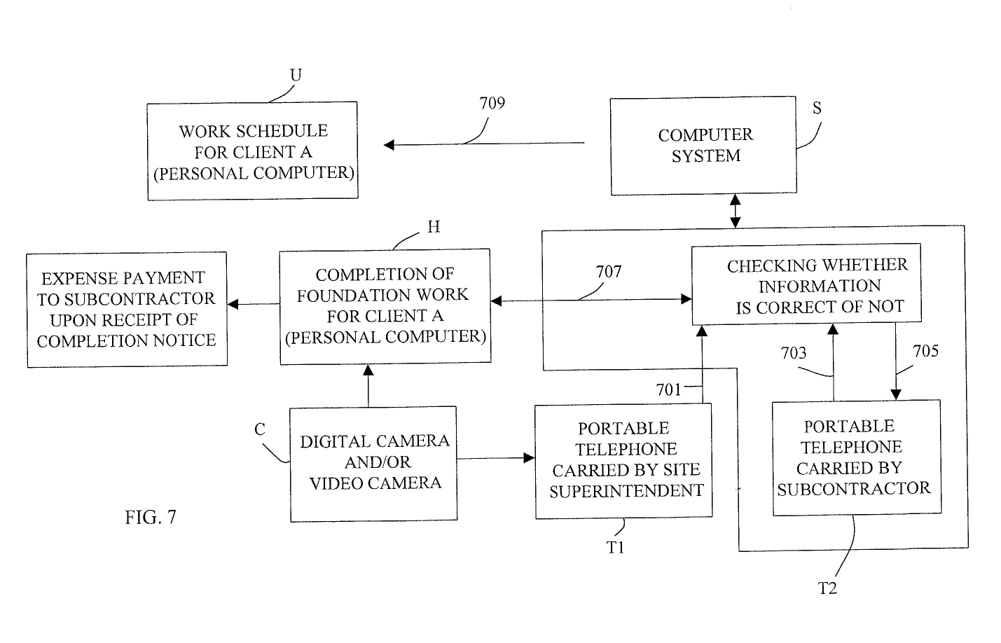

The work progress information particularly reporting completion of each work stage is described with reference to FIG. 7. At least two of the superintendent, the subcontractors and the like independently transmit 701 and 703 the information in real-time reporting completion of a work stage including still images made by their digital cameras or dynamic images made by their digital video cameras C to the system S from their portable telephones T1 and T2 or the like via the network. The system S then determines whether conformity is established between the contents of these messages transmitted from two or more persons. When it is determined that the information transmitted 703 by the subcontractor is erroneous, the system S transmits 705 to the portable telephone T2 or the like of the subcontractor and prompts the subcontractor to again input the relevant information. The system S confirms a work stage completion on the basis of the conformity of the information contents transmitted 701 and 703 from the two or more persons and transmits 707 and 709 work stage completion information to the personal computer H of the home builder and the personal computer U of the client. Confirming work completion stage, the system S can also transmit 707 instructions of expense payment for the subcontractor to the personal computer H of the home builder and thereby prompt the home builder to make a payment to the subcontractor.

The work progress information transmitted from the system S to the home builder may be arranged so that the home builder cannot instruct commencement of a new work stage unless the previous work stage has been completed. In this way, any essential work stage can be reliably controlled.

After completion of each respective work stage, the client can inquire on the work progress. Specifically, the client accesses the system S and retrieves the work stage table from the work progress inquiry step. Then, the client may designate the work stage to be inquired, for example, by clicking to confirm the work progress information containing the result of the work stage inspection. In this way, the client can obtain the image data relating to the defect and the repair thereof and the record of the delay, the change and the reasons for the delay and change.

Furthermore, the system S is able to check the work progress and to inform 217 the client and the home builder of, for example, the date and hour of the framework raising ceremony. The client can electronically provide a transfer request to the system S so that, when the client is absent at the place where his/her personal computer is usually installed, the work progress information and the other data can be communicated 219 between the system S and a different device, such as a portable telephone or the like carried by the client, instead of his or her personal computer, via the Internet or the like (see FIG. 2).

When the work progress is not transmitted from the home builder to the system S in accordance with the initial work schedule, the system S prompts 109 the home builder to report the work progress. In addition, the system S prompts the home builder to input 105 and 107 a work stage change or work progress entry, reason for delay of reporting, reason for delay of the work, schedule changes, reason for the change, date of work commencement, actual work progress by image data, respective inspection items, result of the inspection, repair schedule based on the result, address to which the work stage completion report should be sent, explanation of the subsequent work stage and the like.

The system S is adapted to confirm 111 the whereabouts of the site superintendent on the basis of the whereabouts of the portable telephone or the like carried by the site superintendent. Moreover, in response to inquiry from the home builder or the client, the system S is adapted to transmit 113 and 115 the whereabouts and wishes of the home builder or the client to the client or the home builder.

The system S is additionally adapted to record 117 an actual situation in which the system S is read and utilized and in response to inquiry from the home builder to confirm and to inform the home builder of the actual situation in which the system S is read and utilized for each work stage. The system S can provide the personal computer or the like or the portable telephone carried by the home builder or the client with a function in the form of sound, oscillation, light emission or the like to display messages received. The system S allows the information transmitted to the personal computer or the like or the portable telephone or the like of the home builder or the client to be read in the form of letters, sound or image.

Should the liaison information or the occasional information relate to an emergency, regardless of whether the work is progressing or has already been completed, the system S gives a warning in the form of sound, oscillation, light emission or the like to the personal computer or the like or the portable telephone of the client, the home builder, the site superintendent or the subcontractor and thereby prompts them to read the emergency information.

The system S is provided with a function to retrieve the respective kinds of information relating to the site superintendent, the delayed work, the building, the client, the work stages, claims and the like. The respective work stages, the principal construction members and the like may be retrieved later to determine the names of respective members, the subcontractor responsible for each work stage and the manufacturer, how to handle the construction members, the possibly occurring trouble, the term of guarantee, the window for after-service or the like.

The system S is additionally provided with a function to analyze the respective kinds of information relating to the work progress, delays and changes, the site superintendent as well as the subcontractor responsible for the delay and the like in order to determine tendencies and characteristics of the delayed work, the reason for such delay, the subcontractor responsible for such delay and the like.

The system S is adapted to store, in the place of the home builders, the clients, all kinds of information and offers the information to the home builders and the clients so that the home builders and the client may inquire of the system S about the desired information as occasion demands all-year-round and throughout the day. In this way, both the home builder and the client are relieved from troublesome operation of storing the work information in their own computers and are able to obtain the desired information merely by accessing the system S, as occasion demands.

For a predetermined term, for example, 10 years or 20 years (in the case of term-extension admitted as a result of the periodic inspection) after work completion, more specifically, after a date of handing over of the building, the system S is adapted to accept an inquiry so that the client can access the system S for the term of guarantee or the information offering contract term to investigate the work progress.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

What is claimed is:

1. A method for handling construction project information related to the construction of a building, the construction project information including content information, work schedule information, work progress information and change order information, the method comprising the steps of:
receiving content information related to the design of a building;
receiving work schedule information that indicates a projected schedule as to when various construction stages of the building are to be completed;
receiving work progress information that indicates the actual progress of the building;
receiving change order information directed to changes in the design of the building; and
providing the construction project information to an authorized party, when requested.

2. The method of claim 1, wherein the construction project information is only available to a requesting party that furnishes an appropriate one of an identification (ID) number, a password, a voiceprint and a cryptogram.

3. The method of claim 1, further including the step of:
revising the work schedule information when the change order information impacts the projected schedule.

4. The method of claim 1, wherein the construction project information further includes profiles of a general contractor, a site superintendent and all subcontractors furnishing at least one of labor and material.

5. The method of claim 4, further including the step of:
notifying at least one of the general contractor and the site superintendent when work progress information is not received for a predetermined time.

6. The method of claim 1, wherein the work progress information includes at least one current image of the construction site and the building which details changes in at least one of the building and construction site that have occurred from at least one previous image.

7. The method of claim 6, further including the step of:
authorizing payment to the subcontractor that has fulfilled its obligation when the at least one current image validates that the subcontractor has furnished at least one of the contracted labor and contracted material.

8. The method of claim 1, further including the step of:
verifying the authorized party received the requested construction project information.

9. The method of claim 1, further including the step of:
requesting updated construction project information from at least one of the general contractor and the site superintendent when required construction project information has not been received within a predetermined time period.

10. The method of claim 1, further including the steps of:
receiving a building site inspection request from a building purchaser;
providing the building site inspection request to at least one of the general contractor and the site superintendent; and
coordinating a mutually acceptable time and date between the building purchaser and at least one of the general contractor and the site superintendent.

11. The method of claim 1, further including the step of:
providing a warning to at least one of the general contractor and the site superintendent when a building purchaser reports a building associated problem.

12. The method of claim 11, further including the step of:
scheduling correction of the reported building associated problem with an appropriate subcontractor.

13. The method of claim 1, wherein the construction project information further includes location information for determining the location of at least one of the general contractor, the site superintendent and the subcontractors furnishing at least one of labor and material.

14. The method of claim 13, wherein the location information is provided by a portable telephone in the possession of at least one of the general contractor, the site superintendent and the subcontractors.

15. A control and inquiry system for handling construction project information related to the construction of a building, the construction project information including content information, work schedule information, work progress information and change order information, the system comprising:
a control and inquiry computer system coupled to a computer network and storing construction project information;
a home builder computer system coupled to the computer network;
a client computer system coupled to the computer network; and
control and inquiry code executing on the control and inquiry computer system and causing the control and inquiry computer system to perform the steps of:
receiving content information related to the design of a building from the home builder computer system;
receiving work schedule information that indicates a projected schedule as to when various construction stages of the building are to be completed from the home builder computer system;
receiving work progress information that indicates the actual progress of the building;
receiving change order information directed to changes in the design of the building; and
providing the construction project information to an authorized party, when requested.

16. The system of claim 15, wherein the construction project information is only available to a requesting party that furnishes an appropriate one of an identification (ID) number, a password, a voiceprint and a cryptogram.

17. The system of claim 15, wherein the control and inquiry code causes the control and inquiry computer system to perform the additional step of:
revising the work schedule information when the change order information impacts the projected schedule.

18. The system of claim 15, wherein the construction project information further includes profiles of a general contractor, a site superintendent and all subcontractors furnishing at least one of labor and material.

19. The system of claim 18, wherein the control and inquiry code causes the control and inquiry computer system to perform the additional step of:
notifying at least one of the general contractor and the site superintendent when work progress information is not received for a predetermined time.

20. The system of claim 15, wherein the work progress information includes at least one current image of the construction site and the building which details changes in at least one of the building and construction site that have occurred from at least one previous image.

21. The system of claim 20, wherein the control and inquiry code causes the control and inquiry computer system to perform the additional step of:
authorizing payment to the subcontractor that has fulfilled its obligation when the at least one current image validates that the subcontractor has furnished at least one of the contracted labor and contracted material.

22. The system of claim 15, wherein the control and inquiry code causes the control and inquiry computer system to perform the additional step of:
verifying the authorized party received the requested construction project information.

23. The system of claim 15, wherein the control and inquiry code causes the control and inquiry computer system to perform the additional step of:
requesting updated construction project information from at least one of the general contractor and the site superintendent when required construction project information has not been received within a predetermined time period.

24. The system of claim 15, wherein the control and inquiry code causes the control and inquiry computer system to perform the additional steps of:
receiving a building site inspection request from a building purchaser;
providing the building site inspection request to at least one of the general contractor and the site superintendent; and
coordinating a mutually acceptable time and date between the building purchaser and at least one of the general contractor and the site superintendent.

25. The system of claim 15, wherein the control and inquiry code causes the control and inquiry computer system to perform the additional step of:
providing a warning to at least one of the general contractor and the site superintendent when a building purchaser reports a building associated problem.

26. The system of claim 25, wherein the control and inquiry code causes the control and inquiry computer system to perform the additional step of:
scheduling correction of the reported building associated problem with an appropriate subcontractor.

27. The system of claim 15, wherein the construction project information further includes location information for determining the location of at least one of the general contractor, the site superintendent and the subcontractors furnishing at least one of labor and material.

28. The system of claim 27, wherein the location information is provided by a portable telephone in the possession of at least one of the general contractor, the site superintendent and the subcontractors.

29. A control and inquiry system for handling construction project information related to the construction of a building, the construction project information including content information, work schedule information, work progress information and change order information, the system comprising:
a control and inquiry computer system coupled to a computer network and storing construction project information;
a home builder computer system coupled to the computer network;
a client computer system coupled to the computer network; and
control and inquiry code executing on the control and inquiry computer system and causing the computer system to perform the steps of:
receiving content information related to the design of a building from the home builder computer system;
receiving work schedule information that indicates a projected schedule as to when various construction stages of the building are to be completed from the home builder computer system;
receiving work progress information that indicates the actual progress of the building;
receiving change order information directed to changes in the design of the building; and
providing the construction project information to an authorized party, when requested, wherein the authorized party includes the home builder computer system and the client computer system.
